(19) United States
(12) Patent Application Publication
(10) Pub. No.: US 2026/0085378 A1
(43) Pub. Date: Mar. 26, 2026

(54) Method of extracting one or more rare and precious metals from a substrate comprising the same

(71) Applicant: Helsingin yliopisto, Helsingin yliopisto (FI)

(72) Inventors: Ari Salmi, Helsinki (FI); Jere Hyvönen, Helsingin yliopisto (FI); Joni Mäkinen, Helsingin yliopisto (FI); Antti Kuronen, Helsingin yliopisto (FI); Axi Holmström, Helsingin yliopisto (FI); Topi Pudas, Helsingin yliopisto (FI); Tom Sillanpää, Helsingin yliopisto (FI); Tapio Kotiaho, Helsingin yliopisto (FI); Edward Haeggström, Helsinki (FI)

(21) Appl. No.: 19/112,318

(22) PCT Filed: Sep. 12, 2023
(86) PCT No.: PCT/FI2023/050517

§ 371 Date: Mar. 17, 2025

(30) Foreign Application Priority Data
Sep. 22, 2022 (FI) 20225819

(51) Int. Cl. C22B 7/00; C22B 11/02; G01N 29/04; G01N 29/34

(52) U.S. Cl. CPC C22B 7/005; C22B 11/025; G01N 29/04; G01N 29/346

(57) ABSTRACT

The present disclosure relates to methods of extracting rare and precious metals (RPMs) from a substrate, in particular from recyclable materials such as electronic waste and exhaust cataly sators. The extraction is based on subjecting regions of interest of the substrate comprising the RPMs to focused high intensity ultrasound waves.

### FIELD

The present disclosure relates to methods of extracting rare and precious metals (RPMs) from a substrate, in particular from recyclable materials such as electronic waste and exhaust catalytic converters, in particular to methods wherein the extraction is based on ultrasound assisted removal of the RPMs from the recyclable material.

### BACKGROUND

With rare and precious metals (RPMs) in great demand by the modern industries, interest has grown in the recent years in finding new sources of them. Traditional mining-extracting minerals and metals from the crust of the Earth-is becoming increasingly more difficult as resource nodes deplete. To solve this, urban mining from electronic waste, for example discarded printed circuit boards (PCBs), is an expanding field. Electronic waste contains high concentrations of RPMs and could thus be used to enrich RPMs back into usable form.

Current techniques for RPM circulation by extraction from electronic waste consume a lot of energy and produce harmful pollution from the chemical processing. The process usually comprises three steps: mechanical pre-processing, pyrometallurgy, and hydrometallurgy. The mechanical pre-processing constitutes e.g. manual PCB disassembly and/or PCB crushing. In the pyrometallurgic step, the pre-processed PCBs are incinerated to separate the metals from other materials. This process causes harmful emissions and toxic waste. In the final hydrometallurgical process, metals are leached. The leaching uses substances which cause toxic fumes or by themselves are highly toxic or caustic, for example cyanide and acids. Bioleaching, which utilizes microorganisms or their metabolites for leaching, is an emerging field that would be environmentally friendly. Unfortunately, leaching rates are low and the microorganisms are easily poisoned by toxic by-products, stopping the leaching process. Hence, bioleaching is currently only performed in laboratory scale.

Accordingly, there is need for further methods for extracting RPMs from recyclable materials.

### SUMMARY

The present disclosure is based on the observation that RPMs can be extracted from substrates such as from recyclable material comprising one or more RPMs by creating controlled focused cavitation at predetermined positions within the substrate immersed into a fluid.

Accordingly, it is an object of the present disclosure to provide a method of extracting one or more rare and precious metals (RPMs) from a substrate comprising the same, the method comprising
i) providing the substrate,
ii) immersing the substrate into a fluid,
iii) scanning at least part of surface of the substrate with ultrasonic waves, wherein intensity of ultrasound at the at least part of the surface of the substrate is less than 1 W/cm²,
iv) recording echoes of the ultrasonic waves,
v) constructing an amplitude map of the at least part of the surface of the substrate based on the recorded echoes,
vi) selecting one or more regions of interest on the at least part the substrate comprising the one or more RPMs based on the amplitude map,
vii) subjecting the one or more regions of interest to focused ultrasonic waves wherein intensity of ultrasound at the one or more regions of interest is at least 1 W/cm², preferably at least 10 W/cm², thereby extracting the one or more RPMs from the substrate to the fluid.

Further objects of the present invention are described in the accompanying dependent claims.

Exemplifying and non-limiting embodiments of the invention, both as to constructions and to methods of operation, together with additional objects and advantages thereof, are best understood from the following description of specific exemplifying embodiments when read in connection with the accompanying drawings.

The verbs “to comprise” and “to include” are used in this document as open limitations that neither exclude nor require the existence of un-recited features. The features recited in the accompanied depending claims are mutually freely combinable unless otherwise explicitly stated. Furthermore, it is to be understood that the use of “a” or “an”, i.e., a singular form, throughout this document does not exclude a plurality.

### BRIEF DESCRIPTION OF DRAWINGS

FIG. 1 shows an exemplary Schematic of HIFU-setup suitable for the method of the present disclosure.

FIG. 2 shows another exemplary Schematic of HIFU-setup suitable for the method of the present disclosure.

FIG. 3 shows A) photograph of the gold pads of a PCB and B) amplitude map of the PCB imaged with the HIFU-transducer.

FIG. 4 shows a coded-excitation scanning acoustic microscope topography map of one extraction area; A) top view showing the shape of the cavitation extraction; B) depth profile showing extraction depth into gold and nickel.

### DESCRIPTION

According to one aspect the present disclosure concerns a method of extracting one or more rare and precious metals (RPMs) from a substrate comprising the same, the method comprising
i) providing the substrate,
ii) immersing the substrate into a fluid,
iii) scanning at least part of surface of the substrate with ultrasonic waves, wherein intensity of ultrasound at the at least part of the surface of the substrate is less than 1 W/cm²,
iv) recording echoes of the ultrasonic waves,
v) constructing an amplitude map of the at least part of the surface of the substrate based on the recorded echoes,
vi) selecting one or more regions of interest on the at least part the substrate comprising the one or more RPMs based on the amplitude map,
vii) subjecting the one or more regions of interest to focused ultrasonic waves wherein intensity of ultrasound at the one or more regions of interest is at least 1 W/cm², preferably at least 10 W/cm², thereby extracting the one or more RPMs from the substrate to the fluid, and preferably also
viii) separating the one or more RPMs from the fluid.

The RPMs are typically selected from rhodium, platinum, gold, ruthenium, iridium, osmium, palladium rhenium, nickel, and silver. Preferable RPMs are gold and platinum, more preferably gold.

The substrate is preferably recyclable material comprising one or more RPMs such as electronic waste or exhaust catalytic converter of a vehicle. A particular electronic waste is printed circuit board (PCB) which comprises significant amount of gold. The fluid comprises preferably water. A particular fluid is water.

According to the method at least part of surface of a substrate is scanned using ultrasonic waves generated by an ultrasound transducer, and echoes of the ultrasound signals are recorded using e.g. an oscilloscope. Then, using a computer, an amplitude map is constructed from the recorded echoes. Next, at least one area of interest comprising the desired RPM(s) is selected from the amplitude map and the selected area is subjected to high intensity focused ultrasound (HIFU) generated by a transducer. The cavitation produced extracts the RPM(s) to the fluid. The one or more RPMs can be separated from the fluid using method known in the art. Exemplary methods are evaporation of the fluid, filtering, and subjecting to magnetic field.

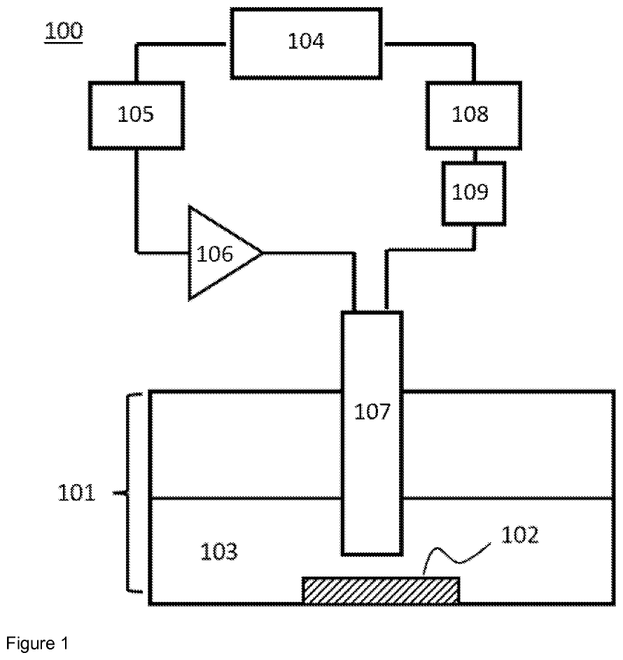

An exemplary system 100 suitable for use in the method is shown in FIG. 1. The system comprises
housing 101 for the substrate 102 and a fluid 103 immersing the substrate,
a computing means 104,
an arbitrary waveform generator 105,
a power amplifier 106,
an ultrasound transducer 107,
oscilloscope 108, and
an attenuating probe 109.

According to an exemplary non-limiting embodiment a signal from the computing means 104 is sent to the arbitrary waveform generator 105 and further via a power amplifier 106 at low settings to the transducer 107. Intensity of the ultrasound at the surface is less than 1 W/cm². Dependent on the surface, intensity of the ultrasound can be significantly lower, e.g. less than 1 mW/cm² or even less than 1 μW/cm². An exemplary intensity range is between 1 μW/cm² and 1 mW/cm². The transmitted signals are reflected from the substrate 102, the echoes are recorded with an oscilloscope 108 using an attenuating probe 109 (e.g., 100x), and stored on the computing means 104. An amplitude map is constructed from the echoes showing higher reflection amplitude from regions of interest distinguishing them from the background areas. To get an image of the substrate, a 3-axis motorized translation stage to scan over the sample can be utilized.

According to an exemplary embodiment the parameters used for ultrasound imaging, including scanning the surface of the substrate with ultrasonic waves, comprise a 12 MHz transducer center frequency, 20 cycles/burst, one transmitted burst per imaging point, 10 μm step size and pressure amplitudes low enough to not damage the surface of the substrate. It should be noted that for imaging in general, it is preferable to use low amplitudes to not to damage the surface of the substrate. Accordingly, in imaging, amplitudes are kept as low as possible, as long as the echoes are discernible. For gold, a pressure amplitude up to 7 MPa is applicable. Regarding cycles/burst in imaging, it is preferable to use as few cycles as possible, typically 3-20, such as 10.

According to a preferable embodiment the imaging is implemented by coded excitation. This improves signal-to-noise-ratio by transmitting chirps instead of sinusoidal pulses. This will greatly improve imaging capability.

Step size is determined by the center frequency and the focusing of the transducer, and hence the optimal imaging step size would depend on the transducer. An exemplary step size is 100 μm for a 12 MHz transducer.

It is possible to perform the ultrasound scan for the whole surface of the substrate. However, it is quite likely that only specific parts of the substrate such as PCB is expected to comprise the RPMs. To avoid unnecessary scanning of the whole surface, a preliminary surface inspection using a machine vision system can be performed, and according to the image produced, amplitude map is generated only from areas of the surface rich in RPMs. According to this embodiment the method comprises, prior to scanning of step iii) producing, using a machine vision system, an image of the surface of the substrate and selecting at least one part of the surface for the ultrasound scanning based on the image. Typically, the substrate is moved e.g. on a conveyor belt while producing the images.

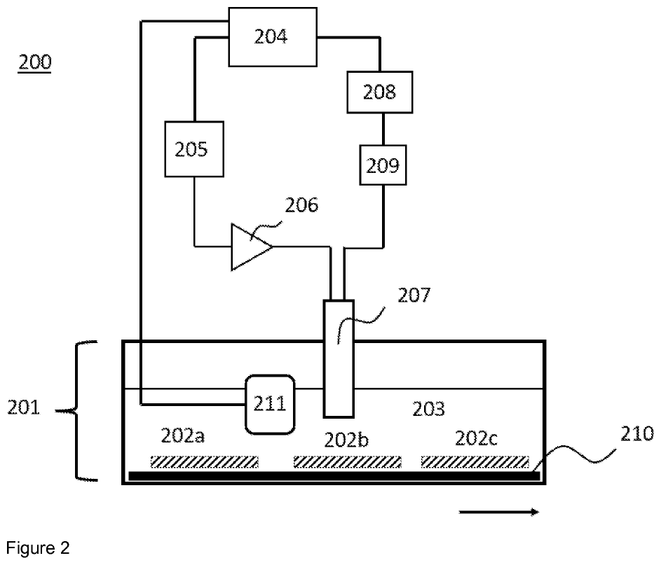

According to another embodiment the method comprises extracting one or more rare and precious metals (RPMs) from plurality of substrates. An exemplary system suitable for this embodiment is shown in FIG. 2. The system 200 comprises
housing 201 for the plurality of substrates 202a-c and for a fluid 203 immersing the plurality of the substrates,
a computing means 204,
an arbitrary waveform generator 205,
a power amplifier 206,
an ultrasound transducer 207,
oscilloscope 208, and
an attenuating probe 209
a conveyor belt 210, and
a machine vision system 211.

The arrow in FIG. 2 shows an exemplary moving direction of the conveyor belt. According to this embodiment the machine vision system is used to determine when the substrate is beneath the ultrasound transducer, and when this is the case, scanning the surface by using the ultrasound transducer. Accordingly, unnecessary scanning of the conveyor belt is avoided. According to this embodiment the method comprises using the exemplary system 200 the following
i) providing a plurality of substrates 202a-c,
ii) positioning the plurality of substrates on a conveyor belt 210 immersed into a fluid 203,
iii) moving the conveyor belt,
iv) imaging, using a machine vision system 211 the conveyor belt comprising the plurality of substrates, thereby producing an image
v) determining, based on the image, when one of the plurality of substrates is scannable using the ultrasonic transducer 207, and then
   a) scanning at least part of surface of the one of the plurality of substrates with ultrasonic waves, wherein intensity of ultrasound at the surface is less than 1 W/cm²,
   b) recording echoes of the ultrasound waves,
   c) constructing an amplitude map of the at least part of the surface based on the recorded echoes,
   d) selecting one or more regions of interest of the at least part of the one of the plurality of substrates based on the amplitude map, and
   e) subjecting the one or more regions of interest to focused ultrasonic waves wherein intensity of the ultrasound at the one or more regions of interest is at least 1 W/cm², preferably at least 10 W/cm², thereby extracting the one or more RPMs from the substrate to the fluid.

For extracting, the transducer is configured to emit focused ultrasonic waves towards the interface between the region of the interest on the substrate and the fluid. An exemplary transducer suitable for the method is a focused piezoelectric transducer. An exemplary operating frequency is 12 MHz. The intensity of the ultrasound at the target is at least 1 W/cm² to allow removing material from the substrate. The HIFU induced cavitation erosion removes material from the substrate. According to an exemplary embodiment, a 500 W continuous wave power amplifier 105 is utilized to transmit high-pressure waves, which cause inertial cavitation in the focus.

The transducer needs to operate at an intensity at the focal spot which is higher than 1 W/cm², more preferably 10 W/cm² or higher. The frequency of the transducer should be at least 20 kHz, preferably between 1 MHz and 15 MHz. An exemplary frequency is 12 MHz. Higher frequency provides a smaller focal spot for more localized extraction. For example, for a 12 MHz transducer with a numerical aperture of 0.85, the cavitation erosion pit radii ranges from 20 μm to 200 μm depending on the sample and ultrasound parameters. Increasing the frequency increases the cavitation pressure threshold so higher frequencies require tighter focusing and/or higher driving voltage of the piezo.

Breaking the sample cohesion, e.g., gold surface, requires higher acoustic pressure amplitude and higher total energy than breaking down adhesion of the sample, e.g., a thin film on a hard substrate. For gold in water, the pressure amplitude at the focus should exceed 30 MPa, preferably higher, such as 40-50 MPa. The cavitation probability increases as the amplitude increases so higher amplitudes provide higher erosion/extraction efficiency. As the amplitude gets higher the erosion area increases as the part of the field that exceeds cavitation threshold increases. Accordingly, the spatial resolution of the method depends on the amplitude. The cavitation threshold is a function of frequency i.e., the higher frequency the higher is the cavitation threshold. For breaking the adhesion, 15 MPa suffices and tuning the amplitude allows tuning the extraction area. The cycle count of the ultrasonic bursts should be preferably between 20 and 80 or more to provide high enough cavitation probability. The pulse repetition frequency (PRF) should be tuned in such a manner that the transducer does not overheat. For example, for a water-immersed 12 MHz single-element piezoceramic, maximum of 1 W-50 W of forward electric power is suitable.

Exemplary parameters used for extraction of material from the substrate f=12 MHz (center frequency of transducer), 30 cycles/burst, 250 000 bursts, Pulse repetition frequency=1 kHz, Peak-positive-pressure=40 MPa. These are parameters for each sonication spot. An exemplary extraction area consists of a 5×5 grid of sonication spots with 20 μm spacing.

Exemplary parameters for step vii) of the method are listed below.
HIFU intensity at the focal spot is higher than 1 W/cm², preferably 10 W/cm² or higher.
The frequency of the transducer should be at least 20 kHz, preferably at least 1 MHz preferably 1 MHz-15 MHz. Even higher frequencies can be used.
the pressure amplitude at the focus is preferably more than 30 MPa, such as 40-50 MPa.
The cycle count of the ultrasonic bursts is between 20 and 80 or more.
Pulse repetition frequency (PRF) is tuned so that the transducer does not overheat. For example, for a water-immersed 12 MHz single-element piezoceramic, maximum average power of 1 W-50 W of forward electric power is suitable.

### Experimental Setup and Sample

The HIFU setup is shown in FIG. 1. The 12 MHz HIFU-transducer contained a custom-built piezo bowl (F5265018, Meggit A/S, Kvistgaard, Denmark) (bandwidth=2 MHz, element diameter 1.9 cm, focal distance 1.5 cm, focal width=140 μm). Signals were generated with an arbitrary waveform generator (FG31052 SERIES, Tektronix, Oregon, USA) and sent to a power amplifier (500A100A, Amplifier Research, Pennsylvania, USA, bandwidth 10 kHz-100 MHz) at either low (imaging) or high (material extraction) settings. Echoes were recorded with an oscilloscope (PicoScope 5442D, Pico Technology, Cambridgeshire, UK) through a 100× attenuating voltage probe (TT-HV250, TESTEC Elektronik GmbH, Hesse, Germany) and saved to a computer. A 3D translation stage (Techno Isel router table, Isel Germany AG, Hesse, Germany) was used to scan the sample in imaging. Both imaging and extraction was performed in reverse-osmosis purified water (RiOs Essential Water Purification Systems, Milli-Q, Hesse, Germany) that had been vacuumed for 20 min. This was done to remove contaminants and control the concentration of dissolved gas, as both particulates and gas bubbles act as nucleation sites for cavitation.

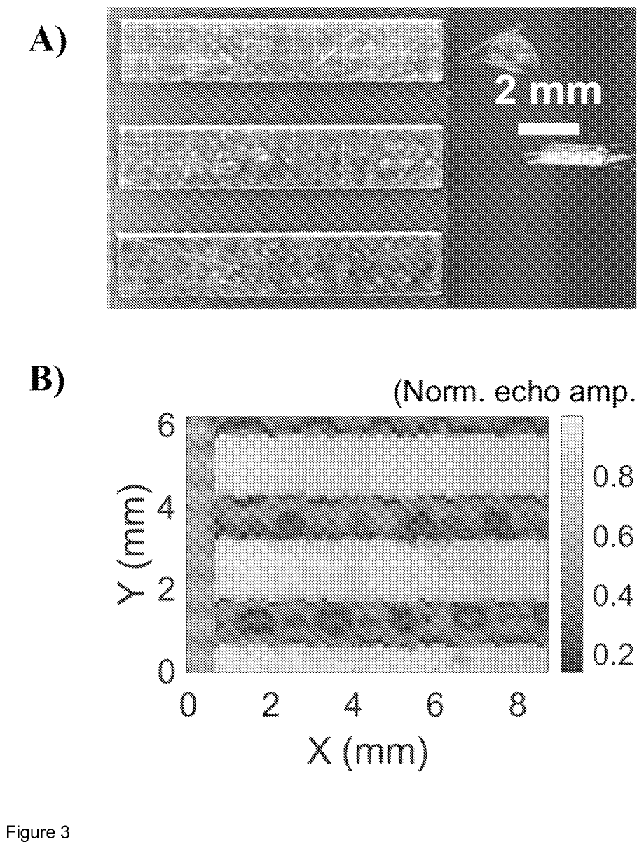

The sample was an obsolete PCB containing gold pads (FIG. 3A). Gold pads consist of a copper base coated by 6 μm of nickel and covered with gold. As the gold-layer thickness on gold pads varies depending on manufacturing method, the gold layer was measured using Rutherford backscattering spectrometry (⁷Li-beam, beam energy 5 MeV) to be (870±20) nm.

### Identifying Regions-of-Interest

A 6×8 mm area of the gold pads was scanned with the HIFU-transducer (f=12 MHz, 20-cycle-bursts, 100 μm step size). An amplitude map was constructed from the echoes (FIG. 3B), showing higher reflection amplitude from the gold pads, distinguishing them from the board.

### Gold Extraction

One gold pad was selected for gold extraction. Three separate extraction areas, 520 μm apart, were sonicated. Each area consisted of a 5×5 grid of sonication spots with 20 μm spacing (area 80 μm×80 μm), each sonication with these acoustic parameters: f=12 MHz, 30 cycles/burst, 250k bursts, PRF=1 kHz, PPPP=40 MPa). Extraction was quantified using a coded-excitation scanning acoustic microscope (CESAM) with a 375 MHz transducer (bandwidth 140 MHz, beam width 2.5 μm, scanning step size 1 μm). The Tx-signal was a 300-500 MHz linear chirp with 1 μs burst length (Gaussian envelope). The measured topography map was used to calculate the amount of removed material from each extraction area.

### Results

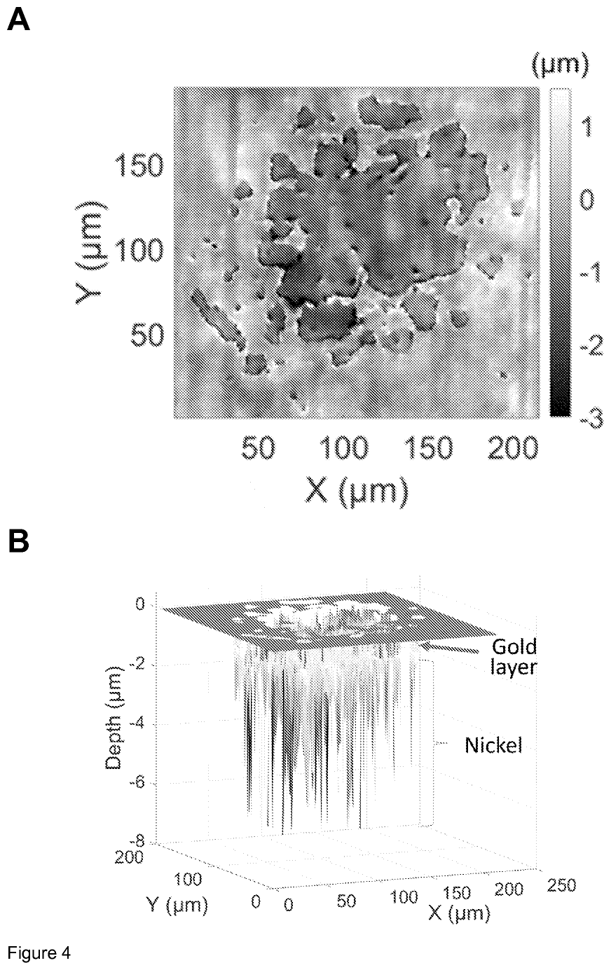

The topography map and depth profile of one extraction area is shown in FIG. 4A, B as an example. For each extraction area, a ROI-mask containing only the areas of cavitation extraction (including small cavitation pits) was made manually. The surface zero-level was determined, and the depth profile was used to calculate the amount of removed gold and nickel. The average extraction areas, volumes, and amounts of removed gold and nickel was calculated to determine the repeatability of the extraction (average+standard deviation): A=(12.2±0.5)·10³ μm², V=(18±2)·10³ μm³, m_{Au}=(190±20) ng and m_{Ni}=(150±30) ng. The variation in volume was larger than that in area, because the bottom of the extraction areas were uneven, as seen in FIG. 4B. The uncertainty in masses of gold and nickel are attributed to the uncertainty in the gold-layer thickness (±20 nm). The standard deviation of the calculated masses and the uncertainty caused by uncertainty in volume were orders of magnitude smaller than the contribution from the layer-thickness uncertainty. Finally, the total amount of removed material from all three extraction areas was calculated, which was mAu, tot=(570±20) ng and m_{Ni,tot}=(440±30) ng.

To quantify the material removal, an in-house coded-excitation scanning acoustic microscope (CESAM; imaging parameters Transducer: f_{C}=375 MHz, BW=140 MHz; Tx coded-excitation: linear chirp 300-500 MHz, 1 μs burst length (Gaussian envelope)) was used. The coded excitation was a linear chirp from 300 to 500 MHz with a duration of 1 μs. As seen from the topography map, the selected extraction area (5×5 grid of sonication spots (20 μm spacing); actuation parameters for each sonication spot: f=12 MHz, 30 cycles, 250k bursts, PRF=1 kHz, pressure amplitude p_{PPP}=40 MPa) are clearly visible. The depth profile was subsequently used to quantify the material removal.

To collect the gold particles, the extracted particulates could be filtered from the water. Nickel is ferromagnetic and could thus easily be separated from gold. A method for separating gold particles from complex water solutions, such as metal-organic-framework/polymer composites is disclosed By Sun, D. T. et al in Journal of the American Chemical Society, vol. 140, no. 48, pp. 16697-16703, 2018.

The specific examples provided in the description above should not be construed as limiting the scope and/or the applicability of the appended claims.

1. A method of extracting one or more rare and precious metals (RPMs) from a substrate comprising the same, the method comprising:
i) providing the substrate,
ii) immersing the substrate into a fluid,
iii) scanning at least part of surface of the substrate with ultrasonic waves, wherein intensity of ultrasound at the surface is less than 1 W/cm²,
iv) recording echoes of the ultrasonic waves,
v) constructing an amplitude map of the at least part of the surface of the substrate based on the recorded echoes,
vi) selecting one or more regions of interest of the at least part of the surface of the substrate based on the amplitude map, and
vii) subjecting the one or more regions of interest to focused ultrasonic waves, wherein the intensity of ultrasound at the one or more regions of interest is at least 1 W/cm², thereby extracting the one or more RPMs from the substrate to the fluid.

2. The method according to claim 1, further comprising producing, using a machine vision system, an image of the surface of the substrate prior to step iii) and selecting the at least one part of the surface of the substrate for the scanning based on the image.

3. The method according to claim 2, further comprising moving the substrate while producing the image.

4. The method according to claim 1, wherein the ultrasonic waves of step iii) produce a pressure amplitude of 7 MPa or less at the surface, and comprise 3-20 cycles/burst.

5. The method according to claim 1, wherein the ultrasonic waves of step vii) comprise one or more of: centre frequency of 2-30 MHz, 30-80cycles/burst, or a pulse repetition frequency at least 1 kHz.

6. The method according to claim 1. further comprising:
viii) separating the one of more RPMs from the fluid.

7. The method according to claim 6, wherein the separating comprises one or more of evaporating the fluid, filtering, and subjecting to magnetic field.

8. The method according to claim 1, wherein the RPMs are selected from a group consisting of rhodium, platinum, gold, ruthenium, iridium, osmium, palladium rhenium, nickel, and silver.

9. The method according to claim 1, wherein the substrate is recyclable material.

10. The method according to claim 9, wherein the recyclable material is selected from the group consisting of electronic waste and exhaust catalytic converters.

11. The method according to claim 10, wherein the electronic waste is printed circuit board.

12. The method according to claim 1, wherein the fluid comprises water.

13. The method according to claim 1, wherein the fluid is water.

14. The method according to claim 1, wherein the intensity of ultrasound at the one or more regions of interest is at least 10 W/cm².

15. The method according to claim 1, wherein the ultrasonic waves of step iii) produce a pressure amplitude of 7 MPa or less at the surface, and comprise 3-5 cycles/burst.

16. The method according to claim 1, wherein the one or more RPMs are selected from gold or platinum.

17. The method according to claim 1, wherein the one or more RPMs is gold.
